(19) United States
(12) Patent Application Publication
(10) Pub. No.: US 2021/0232095 A1
(43) Pub. Date: Jul. 29, 2021

(54) DEVICE FOR ADJUSTING A SHAKE

(71) Applicant: ETA SA Manufacture Horlogere Suisse, Grenchen (CH)

(72) Inventor: Laurent KAELIN, Sonviler (CH)

(73) Assignee: ETA SA Manufacture Horlogere Suisse, Grenchen (CH)

(21) Appl. No.: 17/155,391

(22) Filed: Jan. 22, 2021

(30) Foreign Application Priority Data
Jan. 29, 2020 (EP) 20154401.2

(51) Int. Cl. G04B 18/00; G04B 17/32

(52) U.S. Cl. CPC G04B 18/006; G04B 17/32

(57) ABSTRACT

A device for adjusting a shake and more particularly a bar (100) for a balance (210) configured to be fastened and positioned on a bottom plate (200) by means of at least one fastening member (205). The bar (100) includes a reception opening (111) configured to receive a balance (210) and at least one plate (110) configured to be moved so as to adjust the distance between the at least one plate (110) and the bottom plate (200), at least one lever arm (120) configured to move the at least one plate (110) and at least one foot (130) configured to be in contact with the bottom plate (200) so as to make a mechanical connection and to move the at least one plate (110).

### CROSS REFERENCE TO RELATED APPLICATIONS

This application is claiming priority based on European Patent Application No. 20154401.2 filed on Jan. 29, 2020. The content of which is incorporated herein by reference.

### TECHNICAL FIELD

The present invention relates to a mechanical timepiece equipped with a device for adjusting the shake of a rotating wheel, in particular the shake of a balance.

### TECHNOLOGICAL BACKGROUND

It is known to adjust the shake of the balance arbor by an adjustment of the height of the plate of the balance bar by means of adjusting screws. By screwing or unscrewing the adjusting screws in a substantially homogeneous way, it is thus possible to vary the height of the plate of the balance bar, that is to say the relative distance of this plate to the bottom plate.

Another known variant consists in having a fixed screw, being able to be used as a frame of reference because once screwed the horologist will no longer touch it, and an adjusting screw, which according to the screwing direction will be mounted the balance bar or will lower it in the manner of a screw-nut system.

Thus, the horologist who adjusts the shake of the balance must act on the adjusting screw or screws by successively and repeatedly rotating it or them until the plate reaches a height defining a correct shake for the balance.

However, this manual adjustment is often tedious for a heterogeneous result.

### SUMMARY OF THE INVENTION

The present invention proposes to resolve all or part in the form of a bar for a balance, preferably of a balance, said bar being configured to be fastened and positioned on a bottom plate by means of at least one fastening member configured to apply a force, preferably a stress and/or a torque to said bar; said bar comprising a reception opening configured to receive a balance and at least:
One plate; said at least one plate being configured to be moved so that the distance between said at least one plate and said bottom plate varies;
One lever arm: said at least one lever arm being configured to move said at least one plate when said force is applied on said at least one lever arm; and,
One foot: said at least one foot being configured to be in contact with said bottom plate so as to make a mechanical connection and to transmit said force applied on said at least one lever arm so as to move said at least one plate.

Thanks to this arrangement, it is possible to adjust the shake of the balance in a precise and automated manner.

According to one embodiment, said bar comprises at least one support configured to be in contact with said bottom plate; said at least one lever arm being disposed between said at least one support and said at least one foot.

Thanks to this arrangement, said bar is stabilized.

According to one embodiment, said at least one plate being configured to be deformed so that the distance between said at least one plate and said bottom plate varies when said force is applied on said at least one lever arm.

Thanks to this arrangement, the deformation of said at least one plate makes it possible to vary the distance between said at least one plate and said bottom plate varies when said force is applied on said at least one lever arm.

According to one embodiment, said at least one lever arm being configured to be deformed when said force is applied on said at least one lever arm.

Thanks to this arrangement, the deformation of said at least one lever arm makes it possible to vary the distance between said at least one plate and said bottom plate varies when said force is applied on said at least one lever arm

According to one embodiment, said mechanical connection is an occasional connection, a straight linear connection and/or a pivot connection.

Thanks to this arrangement, it is possible to adjust the shake of the balance by moving said at least one plate.

According to one embodiment, said at least one lever arm comprises at least one fastening opening configured to receive at least one fastening member so as to fasten said bar to said bottom plate.

Thanks to this arrangement, it is possible to adjust the shake of the balance by moving said at least one plate via said force is applied on said at least one lever arm.

According to one embodiment, said at least one plate comprises said reception opening.

Thanks to this arrangement, it is possible to slide the arbor of the balance until the buckling.

According to one embodiment, said reception opening comprises a first center and/or said at least one fastening opening comprises a second center.

Thanks to this arrangement, it is possible to determine the shake of the balance by determining the inclination of the said at least one plate.

According to one embodiment, said at least one foot is between said first center and said second center.

Thanks to this arrangement, it is possible to adjust the shake of the balance by determining the inclination of the said at least one plate.

According to one embodiment, said mechanical connection is aligned between or with said first center and said second center, preferably said mechanical connection is aligned along an axis formed by said first center and said second center.

Thanks to this arrangement, it is possible to adjust the shake of the balance by determining the inclination of the said at least one plate.

According to one embodiment, said straight linear connection and/or said pivot connection forms or form an angle between 70° and 90°, in particular between 80° and 90° and preferably between 85° and 90° relative to said axis formed by said first center and said second center.

Thanks to this arrangement, it is possible to adjust the shake of the balance by determining the inclination of the said at least one plate.

According to one embodiment, said at least one foot is closer to said at least one lever arm than to said at least one plate.

Thanks to this arrangement, the lever arm is proportioned.

### BRIEF DESCRIPTION OF THE FIGURES

The invention will be described hereafter in a more detailed way with the aid of the appended drawings, given by way of non-limiting examples, wherein:

FIG. 1A illustrates an example of implementation of the bar according to a first embodiment;

FIG. 1B shows a sectional view of the bar of FIG. 1A according to a first embodiment;

FIG. 2 presents a top view of the bar according to a first embodiment;

FIGS. 3A-3C disclose an example of implementation of the bar according to a second embodiment.

### DETAILED DESCRIPTION OF THE INVENTION

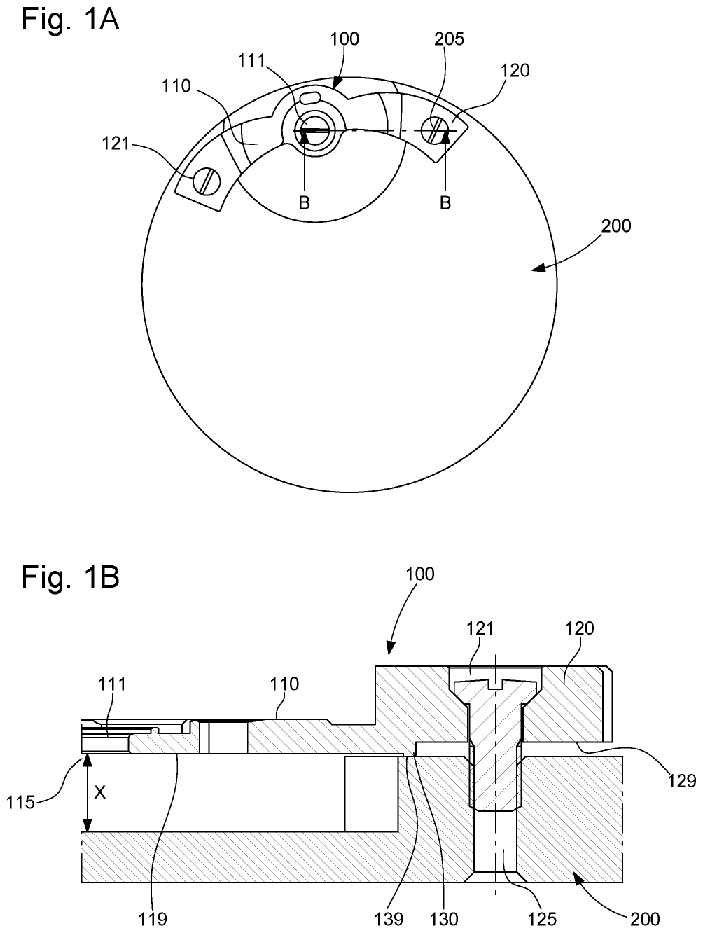

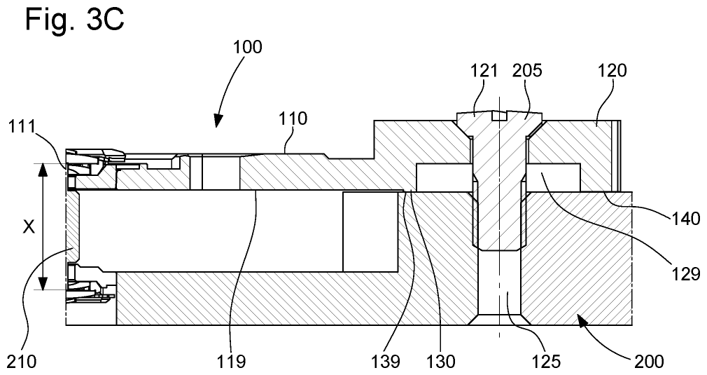

The present invention, shown in FIGS. 1A and 3A on a bottom plate, makes it possible to adjust the balance shake in an easy and automated manner thanks to a bar 100 for a balance 210 and this even if a bar 100 for a balance 210 is cased. Said bar 100 for a balance 210 or of a balance 210 comprises a reception opening 111, including a first center 115, for receiving an end of the arbor of said balance 210 in its so-called first center 115 or at the very least close to its so-called first center 115. The other end of the arbor of said balance 210 rests in a bed provided for this purpose on a bottom plate 200.

Indeed, said balance 210 is located between said bar 100 according to the invention and said bottom plate 200, whereon said bar 100 is fastened and positioned by means of at least one fastening member 205 that may be in the form of a screw 205. Said at least one screw 205 is configured, or said at least one fastening member 205 is configured to apply a force, more specifically a stress and/or a torque to said bar 100.

Said bar 100 comprises at least one plate 110, at least one lever arm 120, at least one foot 130 and/or at least one support 140 according to the embodiments.

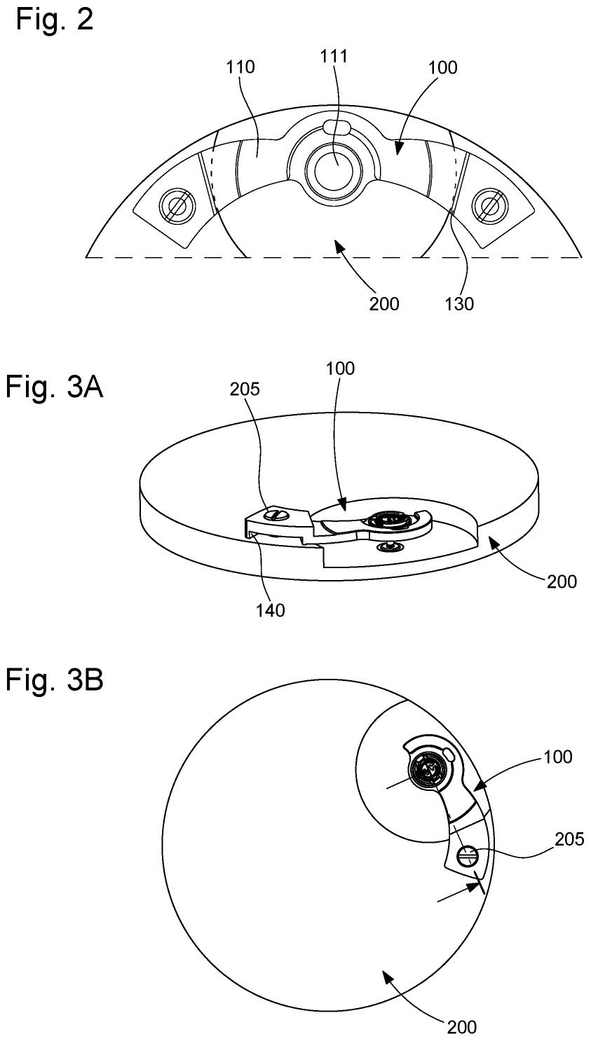

Indeed, according to a first embodiment illustrated in FIGS. 1A-2, said bar 100 passes through and may comprise a plate 110, two lever arms 120, and two feet 130.

According to a second embodiment disclosed in FIGS. 3A-3C, said bar 100 is suspended and may comprise a plate 110, a lever arm 120, a foot 130 and a support 140.

Said at least one plate 110 is configured to be moved or, according to one embodiment, to be deformed so that the distance between said at least one plate 110 and said bottom plate 200 varies, more exactly, said at least one plate 110 comprises a first surface 119, and it is this distance between the first surface 119 of said bar 100 and said bottom plate 200 that varies. As follows from the preceding paragraphs, it is said at least one plate 110 that comprises said reception opening 111, as shown particularly in FIGS. 1A, 2 and 3C, and when the distance between the first surface 119 of said bar 100 and said bottom plate 200 is optimal, said bar 100 is buckled.

In the first embodiment, this variation is possible thanks to said at least one lever arm 120, which is configured to move said at least one plate 110 when said force is applied on said at least one lever arm 120. Indeed, when the force or the torque is applied on said at least one fastening member 205, that is to say said at least one screw 205, said at least one lever arm 120 is moved closer to said bottom plate 200, and, by pivot, by means of said at least one foot 130, said at least one plate 110 is moved or even elastically deformed.

It is surely pointless to specify that, as can be seen in FIG. 1A, said bar according to the first embodiment is fastened to its two ends. From that moment on, when at least one of the two lever arms 120 is moved closer to said bottom plate 200, said at least one plate 110 is moved or even elastically deformed because the other end is fastened via at least one fastening member 205 to said bottom plate 200.

In the case of the second embodiment, this variation is possible thanks to the deformation of said at least one lever arm 120. Indeed, when said force is applied on said at least one lever arm 120, said at least one support 140 being in contact with said bottom plate 200 leads said at least one lever arm 120 to elastically deform and therefore moves said at least one plate 110. It is certainly important to specify that by movement or variation of the distance between the first surface 119 of said bar 100 and said bottom plate 200, and this irrespectively of the embodiment, is performed by an increase or a decrease of the angle between the first surface 119 of said bar 100 and said bottom plate 200.

Moreover, said at least one screw 205 is inserted into at least one fastening opening 121, including a second center 125, included in said at least one lever arm 120 and fastens said bar 100 to said bottom plate 200.

Moreover, said at least one lever arm 120 is distant from said bottom plate 200, more exactly, said at least one lever arm 120 comprises a second surface 129 that is opposite said bottom plate 200. Said at least one foot 130, mentioned earlier in the description, comprises, for its part, a contact surface 139, that is to say a surface that could be considered as being more or less the base 139 of said bar 100.

Thus, said at least one foot 130 is configured or said contact surface 139 is configured to be in contact with said bottom plate 200 so as to make a mechanical connection, which may take the form of an occasional, straight linear and/or pivot connection, and to transmit said force applied on said at least one lever arm 120 so as to move said at least one plate 110.

As can be seen in FIG. 1B, on the one hand, said at least one foot 130 is between said first center 115 and said second center 125, preferably said at least one foot 130 is closer to said at least one lever arm 120 than to said at least one plate 110, and on the other hand, the distance between said contact surface 139, that is to say the base 139 of said bar 100 and said first surface 119, the first surface 119 of said bar 100, is shorter than the distance between said contact surface 139 and said second surface 129. This may also be the case in the second embodiment.

Thus, said at least one lever arm 120 may produce a lever by means of said at least one foot 130, and this so-called mechanical connection is aligned between or with said first center 115 and said second center 125, preferably said mechanical connection is aligned along an axis formed by said first center 115 and said second center 125. More specifically, said mechanical connection, that is to say said straight linear and/or pivot connection, forms or form an angle between 70° and 90°, in particular between 80° and 90° and preferably between 85° and 90° relative to said axis formed by said first center 115 and said second center 125 so as to adjust the shake of the balance by determining the inclination of the said at least one plate 110 by means of the inclination of said first center 115 and of said second center 125. In other terms, the inclination of the said at least one plate 110 is determined by the elevation of said first center 115 relative to said second center 125.

Of course, the first embodiment could be provided with said at least one support 140 and the second embodiment could be devoid of said at least one support 140 on condition of having at least one securing member configured to maintain the distance between said bottom plate 200 and said second surface 129 and to elastically deform in the manner of an elastomer.

1. A bar (100) for a balance (210), preferably of a balance (210), said bar (100) being configured to be fastened and positioned on a bottom plate (200) by means of at least one fastening member (205) configured to apply a force, preferably a stress and/or a torque to said bar (100); said bar (100) comprising a reception opening (111) configured to receive a balance (210) and at least:
one plate (110); said at least one plate (110) being configured to be moved so that the distance between said at least one plate (110) and said bottom plate (200) varies;
one lever arm (120): said at least one lever arm (120) being configured to move said at least one plate (110) when said force is applied on said at least one lever arm (120); and,
one foot (130): said at least one foot (130) being configured to be in contact with said bottom plate (200) so as to make a mechanical connection and to transmit said force applied on said at least one lever arm (120) so as to move said at least one plate (110).

2. The bar (100) according to claim 1, which comprises at least one support (140) configured to be in contact with said bottom plate (200); said at least one lever arm (120) being disposed between said at least one support (140) and said at least one foot (130).

3. The bar (100) according to claim 1, wherein said at least one plate (110) is configured to be deformed so that the distance between said at least one plate (110) and said bottom plate (200) varies when said force is applied on said at least one lever arm (120).

4. The bar (100) according to claim 1, wherein said at least one lever arm (120) is configured to be deformed when said force is applied on said at least one lever arm (120).

5. The bar (100) according to claim 1, wherein said mechanical connection is an occasional connection, a straight linear connection and/or a pivot connection.

6. The bar (100) according to claim 1, wherein said at least one lever arm (120) comprises at least one fastening opening (121) configured to receive at least one fastening member (205) so as to fasten said bar (100) to said bottom plate (200).

7. The bar (100) according to claim 1, wherein said at least one plate (110) comprises said reception opening (111).

8. The bar (100) according to claim 1, wherein said reception opening (111) comprises a first center (115) and/or said at least one fastening opening (121) comprises a second center (125).

9. The bar (100) according to claim 1, wherein said at least one foot (130) is between said at least one plate (110) and said at least one lever arm (120).

10. The bar (100) according to claim 1, wherein said at least one foot (130) is between said first center (115) and said second center (125).

11. The bar (100) according to claim 1, wherein said mechanical connection is aligned between or with said first center (115) and said second center (125), preferably said mechanical connection is aligned along an axis formed by said first center (115) and said second center (125).

12. The bar (100) according to claim 1, wherein said straight linear connection and/or said pivot connection forms or form an angle between 70° and 90° relative to said axis formed by said first center (115) and said second center (125).

13. The bar (100) according to claim 1, wherein said straight linear connection and/or said pivot connection forms or form an angle between 80° and 90° relative to said axis formed by said first center (115) and said second center (125).

14. The bar (100) according to claim 1, wherein said straight linear connection and/or said pivot connection forms or form an angle between 85° and 90° relative to said axis formed by said first center (115) and said second center (125).
